(19) United States
(12) Patent Application Publication
(10) Pub. No.: US 2010/0193662 A1
(43) Pub. Date: Aug. 5, 2010

(54) FORM PANEL SYSTEM FOR POURED CONCRETE

(76) Inventors: Peter Juen, Jensen Beach, FL (US); Marc Emery, Oldsmar, FL (US); Johann Georg Hofer, Clearwater, FL (US)

Correspondence Address: Maxey Law Offices, PLLC, 15500 Roosevelt Blvd., SUITE 305, CLEARWATER, FL, 33760, US

(21) Appl. No.: 12/365,206

(22) Filed: Feb. 4, 2009

(51) Int. Cl. B28B 7/22; E04C 3/20; E04C 2/20

(52) U.S. Cl. 249/13; 52/846; 52/309.1

(57) ABSTRACT

A concrete form panel system for the pouring of structural concrete panels having integrated furring strips for receiving fasteners includes a form panel body having top and bottom surfaces, opposing first and second ends, and opposing first and second sides. A longitudinally extending beam channel is formed through the top surface of the body from the first end to the second end and parallel to the first and second sides for housing a concrete beam. A furring strip longitudinally extends across the body between the first and the second ends and extends at least in part upwardly into the beam slot. The furring strip is provided with a lower fastener portion extending at least in part parallel to the bottom surface of the body.

### FILED OF THE INVENTION

The present invention relates generally to form systems for poured concrete structures, and more particularly, relating to an improved form system including modular form panels with integrated furring strips for receiving fasteners and with a reinforcing steel supporting system.

### BACKGROUND OF THE INVENTION

It is well known in the construction industry to utilize insulated concrete forms for use in the construction of poured concrete walls, floors, roofs, ceilings and the like. The use of insulated concrete forms (ICFs) have experienced increasingly widespread use because they are lightweight, easily cut, excellent insulators, and good barriers to air and moisture. Insulated concrete forms are typically manufactured from plastic foams. Manufacturers create many different foams by varying ingredients and manufacturing methods. IFCs are routinely made from expanded polystyrene (EPS), extruded polystyrene (XPS), polyurethane, a cement-foam composite, or other resins. The insulated concrete forms may either be removed once the concrete has hardened, or left in place to provide a thermal barrier and sound insulation to the concrete structure.

It is known in the art to attach furring strips of wood to the concrete structure for receiving fasteners, such as drywall fasteners, in the attachment of interior finishing to the hardened concrete structure. The furring strips are attached or anchored to the concrete structure during forming of the structure or once the concrete has hardened. There are several inherent problems with either of these methods, in the first method, the wooden furring strips are exposed to prolonged moisture as the concrete sets and often warp as a result, and thus making the fastening of interior finishing difficult. In the second method, the furring strips are attached using penetrating fasteners that are driven through the furring strip and into the concrete structure. The driving of the penetrating fasteners often results in chipping, cracking, or otherwise damaging at least the surface of the concrete structure to which the furring strips are attached. In both methods, the anchors or fasteners used to attached the furring strips to the concrete structure may protrude outwardly from the furring strip making flush and smooth attachment of finishing to the concrete structure difficult.

At least one attempt has been made to try and solve these problems with an insulated concrete panel system and a plastic stud. In this existing form system at least two separate insulating panels are placed side-by-side at a spaced distance into a rectangular outer form with a gap between the insulating panels. A plastic stud is then placed within the gap with the sides of the stud abutted against the facing surfaces of the insulating panels, and thus forming a complete surface onto which concrete may be poured to form a concrete panel having an elongated beam with the stud embed therein. The plastic stud must be anchored in place to ensure it does not move during pouring of the concrete. An additional insulating strip may be placed along the top of the plastic stud prior to the pouring of concrete to provide a barrier between the plastic stud and the elongated beam. Reinforcing steel may be positioned in the rectangular form and may be supported by separate supports positioned within the form.

While this existing form system does provide a solution to the above problems, the existing form system is complicated and requires a considerable amount of labor in setting up for the pouring of a structural concrete panel, and thus cost of using the system could be prohibitively expensive. In addition, a potential drawback to the existing form system is that it does not provide a thermal barrier to the plastic stud. Another potential drawback is the existing form system is not easily adaptable to form structural concrete panels of different dimensions. Further yet, another potential drawback is the existing form system cannot be used to create a cast-in-place structural concrete panel. Further yet, another potential drawback is utility chases cannot be easily cut into the insulating panels.

### SUMMARY OF THE INVENTION

Accordingly, there is a need for an improved form panel system that overcomes the drawbacks of the existing form system, is inexpensively manufactured, and includes an improved reinforcing steel support system.

To achieve these and other advantages, in general, in one aspect, a form panel for poured concrete is provided. The form panel includes a body of an insulating material having opposing first and second surfaces, opposing first and second ends, and opposing first and second sides. The body is provided with a longitudinally extending beam channel formed through the first surface of the body from the first end to the second end and parallel to the first and second sides for housing a concrete beam. A furring strip longitudinally extends in the body between the first and the second ends. The furring strip has a lower fastener receiving portion and at least one vertical portion. The lower fastener receiving portion extends at least in part parallel to the second surface at an inwardly spaced distance therefrom. The at least one vertical portion extends at least in part into the longitudinally extending beam channel. The body is provided with a marking on the second surface indicating the perimeter of the lower fastener receiving portion.

In an embodiment, the body is made of an expanded plastic material, including expanded polystyrene or of extruded polystyrene.

In an embodiment, the furring strip is provided with opposite ends that terminate at an inwardly spaced distance from the opposing first and second ends of the body to provide a region that can be cut out to create a chase for utilities.

In an embodiment, the at least one vertical portion of the furring strip extends at least in part into the longitudinally extending beam channel centered therein.

In an embodiment, the at least one vertical portion extends into the longitudinally extending beam channel along a continuous length of the furring strip between opposite ends thereof.

In an embodiment, the at least one vertical portion is provided with a plurality of openings to permit the concrete casting to migrate through and around the furring strip during poring of the concrete to more readily anchor and hold the furring strip in the hardened concrete casting.

In an embodiment, the concrete form panel includes at least one reinforcing steel supporting member engagable with the at least one vertical portion of the furring strip such that the at least one reinforcing steel supporting member is enabled to support a reinforcing steel member within the longitudinally extending beam channel.

In an embodiment, the at least one reinforcing steel supporting member is engagable with an edge of the at least one vertical portion.

In an embodiment, the furring strip is provided with two transversely spaced vertical portions and is U-shaped in transverse cross section.

In an embodiment, the at least one reinforcing steel supporting member is engagable with the two vertical portions of the furring strip such that the at least one reinforcing steel supporting member is enabled to support a reinforcing steel member within the longitudinally extending beam channel.

In an embodiment, the furring strip is T-shaped in transverse cross section, and the at least one vertical portion can be positioned centrally within the longitudinal beam channel.

In general, in another aspect, a concrete form panel for poured concrete is provided. The concrete form panel includes a body of an expanded plastic material having opposing first and second surfaces, opposing first and second ends, and opposing first and second sides. The body is provided with a longitudinally extending beam channel formed through the first surface of the body from the first end to the second end and parallel to the first and second sides for housing a concrete beam. A furring strip longitudinally extends in the body between the first and the second ends. The furring strip has a lower fastener receiving portion and at least one vertical portion. The lower fastener receiving portion extends at least in part parallel to the second surface at an inwardly spaced distance therefrom. The at least one vertical portion extends at least in part into the longitudinally extending beam channel. The furring strip is provided with a plurality of reinforcing steel supporting members longitudinally spaced along the at least one vertical portion within the longitudinally extending beam channel for supporting reinforcing steel within the longitudinally extending beam channel. The body provided with a marking on the second surface indicating the perimeter of the lower fastener receiving portion.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a perspective view in partial cross-section of a concrete form system including form panels constructed in accordance with the principles of the present invention and a poured concrete structure;

FIG. 2 is a side elevation view of three form panels arranged end-to-end in longitudinal cross-section;

FIG. 3 is a side elevation view of a single form panel in lateral cross-section;

FIG. 4 is a side elevation view of an alternate embodiment of a single form panel in lateral cross-section;

FIG. 5 is a sectional end view of a form panel system including the form panels of the present invention, with a poured concrete structure and wall finishing attached to the concrete structure through the form panels; and

FIG. 6 is a bottom view of a single form panel in accordance with the present invention.

### DETAILED DESCRIPTION OF THE INVENTION

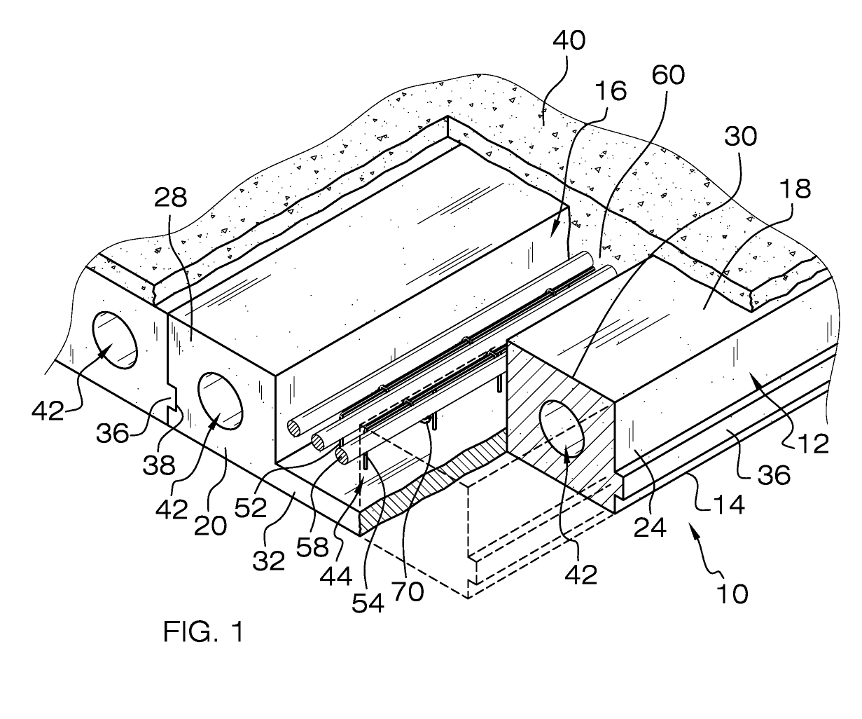

Reference will now be made in detail to the preferred embodiments of the present invention, examples of which are illustrated in the accompanying drawings. With reference to FIG. 1, there is shown a perspective view, in partial cross-section, a form system 10 for poured concrete comprising form panels 12 in accordance with the principals of the present invention. The form system 10, comprising one or more form panels 12, is intended for use in the manufacture of pre-cast, site-cast, and cast-in-place reinforced concrete panels with support joists or beams having integral furring strips.

In FIGS. 1-3, each form panel 12 comprises an elongated body 14 of an insulating material. The body 14 can made of a plastic material, for example of expanded polystyrene or of extruded polystyrene. The body 14 can be made of other materials having thermal and sound insulating properties. The body 14 can be manufactured by several different known methods, for example including extrusion, molding, milling or hot-wire cutting from larger stock material. The body 14 of the form panel 12 is provided with a longitudinally extending beam channel 16 formed through a first surface 18 from a first end 20 to a second end 22 and parallel to first and second sides 24 and 26, respectively. The body 14 further comprises a second surface 34 opposite of the first surface 18. The beam channel 16 divides the body 14 into a pair of upstanding piers 28 and 30 that are interconnected at the bottom by a web 32. After casting, the first surface 18 becomes an inward facing surface, and the second surface 34 becomes an outward facing surface. The width and height of each pier 28 and 30, and the depth of the beam channel 16 can be adjusted to meet beam design requirements of a particular concrete panel.

Sides 24 and 26 can be, respectively, provided laterally with a tongue 36 and a groove 38 having a mating shape longitudinally extending along at least part of the length of the body 14. In this manner, a plurality of form panels 12 arranged side-by-side can be securely connected to one another in a joint-wise coupling so as to assemble a form system 10 for the manufacture of a poured concrete panel 40, as shown in FIG. 1. Alternatively, or in addition to, form panels 12 arranged side-by-side can be securely connected to one another using an appropriate adhesive. Additionally, ends 20 and 22 can be, respectively, provided longitudinally with a tongue and a groove (each not shown) having a mating shape extending transversely along at least part of the width of the body 14. In this manner, a plurality of form panels 12 arranged end-to-end can be securely connected to one another in a joint-wise coupling. Alternatively, or in addition to, form panels 12 arranged end-to-end can be securely connected to one another using an appropriate adhesive.

A typical panel 12 will have a depth, as measured from the top surface 18 to the bottom surface 34, of between 6 to 16 inches, a width measured from side 24 to side 26, of between 16 to 48 inches, and a length measured from end 20 to end 22, of between 12 and 96 inches. A typical panel 12 will have, as measured from the top surface 18 to the bottom of the beam slot 16, a pier height of between 4 to 12 inches. A typical panel will have beam slot width of between 4 to 8 inches.

The body 14 can be provided with one or more utility chases 42 longitudinally formed through one or both piers 28 and 30 permitting the running of utilities, such as, but not limited to, cabling, electrical wiring, and plumbing.

The form panel 12 comprises a longitudinal furring strip 44 extending in the body 14 between ends 20 and 22, and vertically between the top and bottom surfaces 18 and 34. The furring strip 44 can be integrated in the material of the body 14 during the molding, casting or extruding of the body 14. The furring strip 44 is made of a material having suitable structural characteristics, for example expanded metal, cold-rolled metal, galvanized steel, welded wire or plastics.

The furring strip 44 is longitudinally extending in the body 14 along the length of the body between ends 20 and 22. The furring strip 44 extends at least in part upwardly from web 32 into the beam channel 16 between piers 28. In this manner, the furring strip 44 is incorporated by a beam 60 of the concrete casting 40 and is firmly held in place once the casting has hardened. Preferably, the furring strip 44 extends at least in part upwardly from web 32 into the beam channel 16 along a continuous length of the furring strip between opposite ends 48 and 50 thereof to be incorporated in the casting.

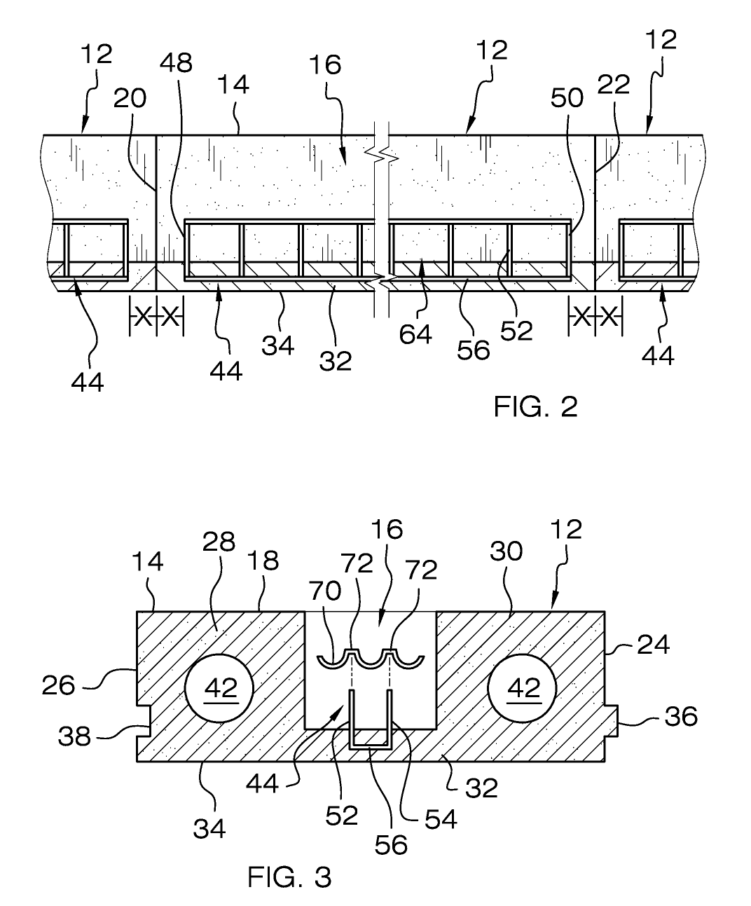

As best seen in FIG. 2, which shows three form panels 12 arranged end-to-end, the furring strip 44 terminates within the body 14 at a spaced distance X from each end 20 and 22 providing a gap twice the distance of X between the ends of the furring strips of adjacent form panels. In this manner, once the concrete casting 40 has hardened, a utility chase (not shown) can be cut into the body 14 along the seam of adjoining form panels 12 to permit the running of utilities.

In one embodiment, as best seen in FIG. 3, the furring strip 44 is U-shaped in transverse cross-section, including two horizontally spaced vertical portions 52 and 54 longitudinally extending the entire length of the furring strip, and a lower fastener receiving portion such as planar portion 56 interconnecting the vertical portions 52 and 54 at the bottoms thereof. Vertical portions 52 and 54 extend at least in part upwardly from web 32 into the beam slot 16, and are spaced from facing surfaces 72 and 74, respectively, of the piers 28 and 30. One or both vertical portions 52 and 54 of the furring strip 44 can be provided with openings, such as the plurality of longitudinally spaced openings 64 to permit the concrete casting to migrate through and around the furring strip during poring of the concrete to more readily anchor and hold the furring strip in the hardened concrete casting 40. The lower portion 52 extends at least in part parallel to the bottom surface 34 at an inwardly spaced distance from the second surface 34. The lower fastener receiving portion 52 is entirely embedded in the body 14 creating a thermal break.

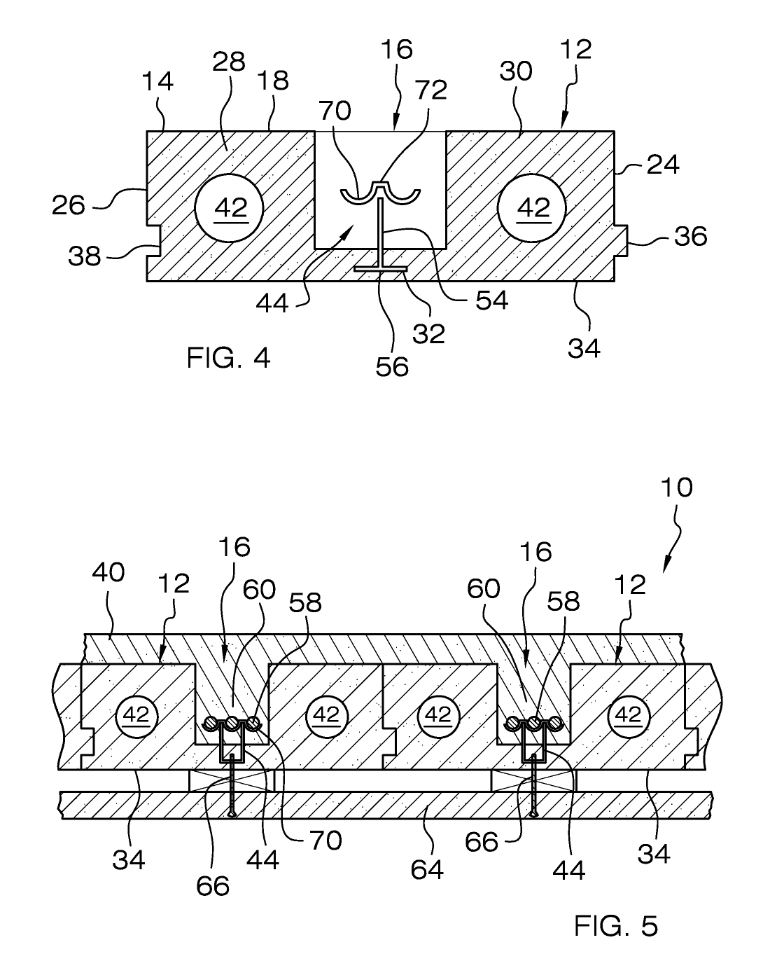

In additional embodiments, it is contemplated, the furring strip 44 could have other cross-sectional shapes, for example the furring strip could have a cross-sectional shape of an inverted T, a Z, or an I, other shapes are also conceivable possible. As seen in FIG. 4, the furring strip 44 is generally T-shaped in transverse cross section, and includes a single vertical portion centered in the beam channel 16.

As shown in FIG. 5, which illustrates a partial cross-sectional view through a wall section, the lower portion 52 of the furring strip 44, advantageously, provides an effective supporting means to permit the attachment of a suitable covering or finishing, for example wall board 64, by penetrating fasteners 66 along the bottom surface (outward facing surface) 38 of the body 14 to the furring strip and thus to a structural beam 60 of the concrete casting 40. In this manner, any tensile force applied to the furring strip 44 is transmitted to and absorbed by the structural beam 60 of the concrete casting 40. It is important to note, the concrete casting 40, formed with panel system 10 herein, can be installed with either the panel system on the exterior or interior side of the building structure.

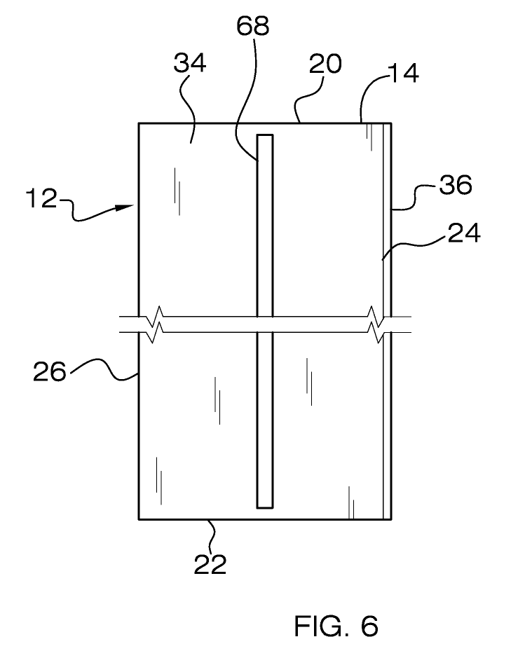

With reference to FIG. 6, the form panel 12 is provided with indicia, an indicator or otherwise marking 68 on the bottom surface 34 of the body 14. The marking 68 identifies a location of the furring strip 44. The marking 68 can identify the perimeter of the lower portion 52 embedded within the body 14. The marking 68 can be completely marked around the entire perimeter of the lower portion 52. The marking 68 could also indicate a center line of the lower portion 52. The marking 68 permits a worker to quickly identify the location of the furring strip 44 within the body 14 when work is being performed on a cast concrete panel, for example when attaching covering or cutting a utility chase into the form panel 12.

The furring strip 44 can be provided with at least one reinforcement structure hanger 70 for supporting a reinforcement structure such as rebar 58 within the longitudinally extending beam slot 16 at an evenly spaced distance from the top surface 18 of the body 14. The at least one reinforcement structure hanger 70 can be integral with the furring strip 44. Alternatively, at least one reinforcement structure hanger 70 can be removably supported by the furring strip 44. In an embodiment, at least one reinforcement structure hanger 70 is supported by and extends across the vertical portions 52 and 54 of the furring strip 44. The at least one reinforcement structure hanger 70 can be provided with one or more seats 72 for receiving or engaging edges of either or both of the vertical portions 52 and 54 for supporting the at least one reinforcement structure hanger. A plurality of reinforcement structure hangers 70 can be provided at spaced positions longitudinally along the furring strip 44. The at least one reinforcement structure hanger 70 can be of various forms, and should not be limited in way to a bent wire configuration as illustrated. For example, the at least one reinforcement structure hanger 56 could also be a continuous flange longitudinally extending along the furring strip 44. The at least one reinforcement structure hanger 56 could be injected molded by a suitable material. The furring strip 44 in any number of different cross sectional geometries can be provided with the reinforcement structure hanger 70 as describe above. Particularly, as shown in FIG. 4, with a furring strip 44 that is T-shaped in cross section.

Other embodiments are possible, for example form panel 12 can be provided with transverse beam slots formed through the top surface 18 and extending transversely across the entire width of body 14 between sides 24 and 26. The vertical portions 52 and 54 of the furring strip 44 could be expanded metal or welded wire form. The furring strip 44 could be extruded or molded by a suitable material.

A number of embodiments of the present invention have been described. Nevertheless, it will be understood that various modifications may be made without departing from the spirit and scope of the invention. Accordingly, other embodiments are within the scope of the following claims.

What is claimed is:

1. A form panel, comprising:
a body of an insulating material having opposing first and second surfaces, opposing first and second ends, and opposing first and second sides, said body is provided with a longitudinally extending beam channel formed through said first surface of said body from said first end to said second end and parallel to said first and second sides for housing a concrete beam;
a furring strip longitudinally extending in said body between said first and said second ends, said furring strip having a lower fastener receiving portion and at least one vertical portion, said lower fastener receiving portion extending at least in part parallel to said second surface at an inwardly spaced distance therefrom, said at least one vertical portion extending at least in part into said longitudinally extending beam channel; and
said body provided with a marking on said second surface indicating the perimeter of said lower fastener receiving portion.

2. The concrete form panel according to claim 1, wherein said body is made of an expanded plastic material.

3. The concrete form panel according to claim 1, wherein said furring strip is provided with opposite ends that terminate at an inwardly spaced distance from said opposing first and second ends of said body.

4. The concrete form panel according to claim 1, wherein said at least one vertical portion of said furring strip extends at least in part into said longitudinally extending beam channel centered therein.

5. The concrete form panel according to claim 1, wherein said at least one vertical portion extends into said longitudinally extending beam channel along a continuous length of said furring strip between opposite ends thereof.

6. The concrete form panel according to claim 1, wherein said at least one vertical portion is provided with a plurality of openings.

7. The concrete form panel according to claim 1, further comprising:
at least one reinforcing steel supporting member engagable with said at least one vertical portion of said furring strip such that said at least one reinforcing steel supporting member is enabled to support a reinforcing steel member within said longitudinally extending beam channel.

8. The concrete form panel according to claim 7, wherein said at least one reinforcing steel supporting member is engagable with an edge of said at least one vertical portion.

9. The concrete form panel according to claim 1, wherein said furring strip is provided with two transversely spaced vertical portions and is U-shaped in transverse cross section.

10. The concrete form panel according to claim 9, further comprising:
at least one reinforcing steel supporting member engagable with said two vertical portions of said furring strip such that said at least one reinforcing steel supporting member is enabled to support a reinforcing steel member within said longitudinally extending beam channel.

11. The concrete form panel according to claim 1, wherein said furring strip is provided with at least one reinforcing steel supporting members for supporting a reinforcing steel member within said longitudinally extending beam channel.

12. The concrete form panel according to claim 1, wherein said furring strip is T-shaped in transverse cross section.

13. A concrete form panel, comprising:
a body of an expanded plastic material having opposing first and second surfaces, opposing first and second ends, and opposing first and second sides, said body is provided with a longitudinally extending beam channel formed through said first surface of said body from said first end to said second end and parallel to said first and second sides for housing a concrete beam;
a furring strip longitudinally extending in said body between said first and said second ends, said furring strip having a lower fastener receiving portion and at least one vertical portion, said lower fastener receiving portion extending at least in part parallel to said second surface at an inwardly spaced distance therefrom, said at least one vertical portion extending at least in part into said longitudinally extending beam channel;
said furring strip provided with a plurality of reinforcing steel supporting members longitudinally spaced along said at least one vertical portion within said longitudinally extending beam channel for supporting reinforcing steel within said longitudinally extending beam channel.
said body provided with a marking on said second surface indicating the perimeter of said lower fastener receiving portion.

14. The concrete panel of claim 13, wherein said furring strip is provided with opposite ends that terminate at an inwardly spaced distance from said opposing first and second ends of said body.

15. The concrete panel of claim 13, wherein said at least one vertical portion extends into said longitudinally extending beam channel along a continuous length of said furring strip between opposite ends thereof.

16. The concrete panel of claim 13, wherein said at least one vertical portion is provided with a plurality of openings.
